(19) United States
(12) Patent Application Publication
(10) Pub. No.: US 2024/0155263 A1
(43) Pub. Date: May 9, 2024

(54) In-Situ Composite Focal Plane Array (CFPA) Imaging System Geometric Calibration

(71) Applicant: Meta Materials Inc., North Billerica, MA (US)

(72) Inventors: Yiannis Antoniades, Fulton, MD (US); Jonathan Edwards, Brookeville, MD (US); David Chester, Edgewater, MD (US)

(21) Appl. No.: 18/387,358

(22) Filed: Nov. 6, 2023

Related U.S. Application Data
(60) Provisional application No. 63/422,872, filed on Nov. 4, 2022.

(51) Int. Cl. H04N 25/75; G06T 7/80; H04N 23/15; H04N 23/16; H04N 25/131

(52) U.S. Cl. CPC H04N 25/75; G06T 7/80; H04N 23/15; H04N 23/16; H04N 25/131; G06T 2200/32; G06T 2207/10004

(57) ABSTRACT

The present disclosure is directed to composite focal plane array (CFPA) imaging systems and techniques for calibrating such imaging systems. An unmanned aerial vehicle has a CFPA imaging system including a plurality of lens assemblies, a plurality focal plane array (FPA) sensors disposed on a planar substrate, and an image processing module. A first processing node of the module receives overlapping image data from the sensors and generates an update for a sensor calibration model based on key points in the overlapping image data. A plurality of other processing nodes receives image data from the sensors. The sensor calibration model is applied to correct the image data, thereby compiling a composite image.

### CROSS REFERENCE TO RELATED APPLICATION

This application claims the benefit under 35 U.S.C. § 119(e) from U.S. Provisional Application No. 63/422,872, entitled “In-Situ Composite Focal Plane Array (CFPA) Imaging System Geometric Calibration,” filed on Nov. 4, 2022. The entirety of the disclosure of the foregoing document is incorporated herein by reference.

### TECHNICAL FIELD

The present disclosure is in the field of imaging systems. More specifically, this disclosure relates to composite focal plane array (CFPA) imaging systems and their calibration.

### BACKGROUND INFORMATION

Wide area persistent motion imaging commonly involves continuous surveillance of a large area using an airborne camera system capable of imaging visible and/or IR wavelengths and is increasingly used for public safety, insurance, disaster relief, search and rescue, smart cities, border surveillance and numerous other use cases. It is an emerging technology, which is creating a new paradigm in providing large scale context relevant for machine learning for the commercial, public safety and military applications.

Image quality is important for the development of automated processing and visualization systems. Since there are no single imaging arrays capable of imaging an area the size of a city at high enough resolution using visible or IR wavelengths to track and distinguish large and small objects on the ground, wide area motion imagery systems employ sensors which produce staring mosaics composed of multiple individual imagers. Since each imager can have a different uncertainty in their geometric calibration parameters, simply tiling the images together can produce a mosaic with large misalignment seams which is frequently unusable for detailed or automated analysis, relevant for systems which can produce petabytes of image data in the span of a few hours.

Gigapixel video can be produced by stitching together individual video streams from multiple focal plane arrays (FPAs), each composed of megapixel sensors, e.g., a staring array, or staring-plane array, e.g., an image sensor composed of an array (typically rectangular) of light-sensing pixels (e.g., visible or IR-sensing pixels) at the focal plane of a lens, such as the lenses used in cell phone cameras and single-lens reflex (SLR) cameras, suitable for the operational wavelength of the FPA sensors, e.g., individual sensors of the FPA. Typical FPA sensors have pixel pitches as small as 0.6 microns to minimize the size of the cameras using FPA sensors. A CFPA typically consists of three or more groups of FPA sensors, each comprising multiple FPAs and its own lens. When pointed to the same ground point, substrates having a CFPA arrangement of sensors, e.g., a CFPA board, can produce staring motion imagery at gigapixel resolution.

Very wide area persistent surveillance is typically performed using multiple airborne platforms using cameras which produce gigapixel-resolution images, e.g., gigapixel cameras. In order to be able to distinguish and track multiple events on the ground, including people, small animals, vehicles, etc. the cameras should cover large ground areas, on the order of tens to hundreds of square kilometers, and have very high spatial resolution (e.g., a per pixel spatial resolution of about 15 cm or more) and near perfect seamless imagery simultaneously. Since there are no single gigapixel FPAs, systems with multiple FPAs are used to create wide area mosaics persistently.

Using CFPA imaging systems can provide adequate wide-area coverage at adequate temporal resolution to distinguish stationary and moving objects. These systems also have enough spatial resolution to detect and track individuals. However, such systems require a corrected geometric sensor model to avoid missing small detections or creating false detections due to artifacts in stitched mosaics. Even for the best sensor designs, changes in the ambient environment, such as temperature and barometric pressure, result in small relative displacements and rotations of the imaging arrays compared to a ground-calibrated condition. These changes result in undesired image artifacts in live video and mosaics, such as geometric ‘seams’ (e.g., mis-matched pixels) and adversely affects the accuracy of both the visual and automated analysis of the imagery for object tracking and information retrieval.

Traditionally, initial models for geometric correction of sensor images are generated by calibrating the array using bundle adjustment optimization and lab-based imagery or collimated light sources. Briefly, bundle adjustments of imaging sensor arrays includes simultaneous refinement of 3D coordinates describing the scene geometry, the relative motion parameters of the platform on which the imaging array is mounted, and optical characteristics of the camera(s) employed to acquire the images. This may be appropriate for the lab condition, but the geometric corrections do not necessarily hold fixed for flight systems encountering varying environmental conditions.

Bundle adjustment has been performed in-situ for aligning video sequences for a single camera over time (e.g., video mosaic), but not for a multitude of overlapping FPA sensors encountered with composite FPA (CFPA) designs, and not for CFPAs acquiring video. A typical computer vision approach to handle multiple FPA sensors is to associate an internal calibration matrix for each focal plane and solve for optimized parameters of the calibration matrix.

The internal calibration matrix includes parameters for at least the focal lengths, FPA sensor pixel sizes, FPA sensor spatial orientations on the CFPA substrate, and optical centers of the CFPA imaging system. However, a separate calibration matrix is necessary for each focal plane and the complexity of the optimization calculation increases as the number of focal planes for CFPA imaging systems increases, e.g., additional lenses create additional focal planes requiring separate calibration matrices.

Early suggested alternate approaches for creating seamless images for CFPA imaging systems sought to use the designed image overlap to align only the spatial orientation parameters corresponding to FPAs used in downlinked video (e.g., the ‘video window’) in live operation. This alignment was performed for each temporal frame of the downlinked video by attempting to shift the FPA images in each frame of created video. This approach creates redundant and wasteful processes given the time scale of the system variations. Furthermore, such approaches constitute local solutions only and aligns the video window subset, and not the whole system.

Therefore, what is needed is a system that performs live, in-situ, model refinement resulting in a global solution suitable for any image mosaic or video subset request (up to and including the full scene mosaic).

### SUMMARY

It has been discovered that a small overlap in images obtained by sensors of a CFPA imaging system enables in-situ image processing for calibration of geometrically seamless mosaic image formation during live operation. This discovery has been exploited to develop the present disclosure, which in part is directed to systems and methods for image processing of wide-area CFPA camera motion imagery mosaics having reduced error from image misalignment.

In general, in a first aspect, the disclosure features an imaging system for a composite focal plane array (CFPA) imaging system, including: multiple lens assemblies each arranged to image light from a common field of view to a corresponding image field at a focal plane of each lens assembly; a plurality of focal plane array (FPA) sensor modules each arranged in multiple sensor groups, each sensor group arranged at the focal plane of one of the lens assemblies corresponding to the sensor group, wherein each FPA sensor module in each of the sensor groups is positioned such that each FPA sensor module acquires an image a different portion of the common field of view of the lens assemblies; and an image processing module arranged to receive image data from the plurality of FPA sensor modules and compile a composite image with image data from at least two of the FPA sensor modules, wherein the at least two of the FPA sensor modules acquire images of adjacent portions of the common field of view and the image data from the at least two FPA sensor modules includes overlapping image data. The image processing module includes a first processing node programmed to receive the overlapping image data and generate an update for a sensor calibration model based on one or more key points common to the overlapping image data from the at least two FPA sensor modules, and multiple additional processing nodes programmed to receive the image data, apply the sensor calibration model to the image data to generate corrected image data, and compile the composite image using the corrected image data from the at least two FPA sensor modules.

Implementations of the imaging system includes one or more of the following features and/or features of other aspects. For example, the sensor calibration model can include one or more internal parameters, the internal parameters being parameters characteristic of each lens assembly that apply to each FPA sensor module in a sensor group. The internal parameters can be shared by more than one of the FPA sensor modules. Shared internal parameters can be selected from the group including: a focal length, an optical center, and a lens distortion (e.g., expressed as a polynomial function or using a look up table).

The sensor calibration model can include one or more external parameters, the external parameters being parameters characteristic of each lens assembly that are different for each FPA sensor module in a sensor group. The external parameters can be shared by more than one of the FPA sensor modules. The shared external parameters can include three angles of optical axis rotation.

The sensor calibration model can include parameters characterizing a location and/or an orientation of each FPA sensor module.

The first processing node can be programmed to identify the key points from the overlapping image data. The key points can be identified based on a two-dimensional intensity gradient in the overlapping image data. The key points can be identified as a feature in the overlapping image data from the at least two of the plurality of FPA sensor modules for which an intensity gradient exceeds a threshold in two orthogonal directions. The key points can be identified in multiple frames acquired by the FPA sensor modules.

The imaging processing module is programmed to update for the sensor calibration model based on image data acquired over a sequence of composite image frames.

The image processing module can include an interconnect for distributing the image data among the first processing node and the plurality of exploitation nodes.

The update for the sensor calibration model can be determined by the first processing node by optimization of a cost function related to a correspondence between key points in the overlapping image data. The optimization can be a nonlinear least squares optimization.

The plurality of FPA sensor modules can be spaced apart from each other on the planar surface. The plurality of FPA sensor modules can be arranged relative to the lens assemblies such that the FPA sensor modules collectively image a continuous area across the field of view. The plurality of FPA sensor modules can be arranged relative to the lens assemblies such that the portion of the field of view imaged by each of the plurality of imaging sensors forms a brick-wall pattern when interleaved to form a composite image of the continuous area.

The plurality of FPA sensor modules of each sensor group can be arranged such that each FPA sensor module of one sensor group images a non-adjacent portion of the field of view relative to the other FPA sensor modules of the sensor group.

The plurality of sensor groups can include three or more sensor groups.

The FPA sensor modules each can include a plurality of sensor elements each configured to detect incident visible and/or infrared light.

The imaging system can include at least three lens assemblies and at least three sensor groups.

In a further aspect, the disclosure features an aerial vehicle including the imaging system. The aerial vehicle can be an unmanned aerial vehicle.

In general, in another aspect, the disclosure features a method of forming a composite image using a composite focal plane array (CFPA), the method including: imaging light from a common field of view to a plurality of sensor groups using a plurality of lens assemblies, each sensor group comprising a plurality of focal plane array (FPA) sensor modules, the plurality of FPA sensor modules all being arranged on a surface of a substrate; acquiring an image using each of the FPA sensor modules, each image corresponding to a different portion of the common field of view; receiving image data from the plurality of FPA sensor modules including image data from at least two of the FPA sensor modules, wherein the at least two of the FPA sensor modules acquire images of adjacent portions of the common field of view and the image data from the at least two FPA sensor modules comprises overlapping image data; generating an update for a sensor calibration model based on one or more key points common to the overlapping image data from the at least two FPA sensor modules; applying the sensor calibration model to the image data to generate corrected image data; and compiling a composite image using the corrected image data from the at least two FPA sensor modules.

Implementations of the method can include one or more of the following features and/or features of other aspects. For example, the sensor calibration model can include one or more internal parameters, the internal parameters being parameters characteristic of each lens assembly that apply to each FPA sensor module in a sensor group. The internal parameters can be shared by more than one of the FPA sensor modules. Shared internal parameters can be selected from the group that includes: a focal length, an optical center, and a lens distortion.

The sensor calibration model can include one or more external parameters, the external parameters being parameters characteristic of each lens assembly that are different for each FPA sensor module in a sensor group. The external parameters can be shared by more than one of the FPA sensor modules. The shared external parameters can include three angles of optical axis rotation.

The sensor calibration model can include parameters characterizing a location and/or an orientation of each FPA sensor module.

The key points can be identified from the overlapping image data. The key points can be identified based on a two-dimensional intensity gradient in the overlapping image data. The key points can be identified as a feature in the overlapping image data from the at least two of the plurality of FPA sensor modules for which an intensity gradient exceeds a threshold in two orthogonal directions. The key points can be identified in multiple frames acquired by the FPA sensor modules. The sensor calibration model can be updated based on image data acquired over a sequence of composite image frames. The update for the sensor calibration model can be determined by a first processing node by optimization of a cost function related to a correspondence between key points in the overlapping image data. The optimization can be a nonlinear least squares optimization.

In one example, an unmanned aerial vehicle has a CFPA system. The CFPA system includes a plurality of lens assemblies, a plurality focal plane array (FPA) sensors disposed on a planar substrate, and an image processing module. There are multiple of the FPA sensors in the field of view of each of the lens assemblies. A first processing node of the module receives overlapping image data from the FPA sensors and generates an update for a sensor calibration model based on key points in the overlapping image data. A plurality of other processing nodes receives image data from the FPA sensors. There is a one-to-one relationship between the other processing nodes of the plurality of other processing nodes and the FPA sensors of the plurality of FPA sensors. The sensor calibration model is applied to correct the image data from the plurality of FPA sensors, thereby compiling a composite image.

Further details and embodiments and methods and techniques are described in the detailed description below. This summary does not purport to define the invention. The invention is defined by the claims.

### DESCRIPTION OF THE DRAWINGS

The foregoing and other objects of the present disclosure, the various features thereof, as well as the disclosure itself may be more fully understood from the following description, when read together with the accompanying drawings in which:

FIG. 1A is a diagrammatic representation of a top view of a single-substrate CFPA with three lens groups in a distributed configuration in accordance with many examples of the disclosure;

FIG. 1B is a diagrammatic representation of a perspective view of a CFPA camera with three lens assemblies imaging to a single CFPA board in accordance with many examples of the disclosure;

FIG. 1C is a diagrammatic representation of a composite image formed using a CFPA with three lens groups in a brick wall configuration in accordance with many examples of the disclosure;

FIG. 1D is a diagrammatic representation of a portion of the composite image shown in FIG. 1C showing image overlap in a calibrated system in accordance with many examples of the disclosure;

FIG. 1E is a diagrammatic representation of the portion of the composite image shown in FIG. 1D showing image overlap in uncorrected system in accordance with many examples of the disclosure;

FIG. 1F is a diagrammatic representation showing a displacement of a pair of common image points in the portion of the composite image shown in FIG. 1E in accordance with many examples of the disclosure;

FIG. 2A is a diagrammatic representation showing aspects of a CFPA camera in accordance with many examples of the disclosure;

FIG. 2B is a diagrammatic representation showing aspects of a sensor group in accordance with many examples of the disclosure;

FIG. 3 is a diagrammatic representation of an example of a CFPA imaging system in accordance with many examples of the disclosure;

FIG. 4 is a diagrammatic representation of an airborne platform mounted with a CFPA camera imaging a target in accordance with many examples of the disclosure; and

FIG. 5 is a diagrammatic schematic representation of an example computer system 1E in accordance with many examples of the disclosure.

### DETAILED DESCRIPTION

The disclosures of these patents, patent applications, and publications in their entireties are hereby incorporated by reference into this application in order to more fully describe the state of the art as known to those skilled therein as of the date of the invention described and claimed herein. The instant disclosure will govern in the instance that there is any inconsistency between the patents, patent applications, and publications and this disclosure.

Unless defined otherwise, all technical and scientific terms used herein have the same meaning as commonly understood by one of ordinary skill in the art to which this disclosure belongs. The initial definition provided for a group or term herein applies to that group or term throughout the present specification individually or as part of another group, unless otherwise indicated.

For the purposes of explaining the invention well-known features of image processing for technology known to those skilled in the art of multi-camera imaging arrays have been omitted or simplified in order not to obscure the basic principles of the invention. Parts of the following description will be presented using terminology commonly employed by those skilled in the art of optical design. It should also be noted that in the following description of the invention repeated usage of the phrase “in one embodiment” does not necessarily refer to the same embodiment.

As used herein, the articles “a” and “an” refer to one or to more than one (e.g., to at least one) of the grammatical object of the article. By way of example, “an element” means one element or more than one element. Furthermore, use of the term “including” as well as other forms, such as “include,” “includes,” and “included,” is not limiting. Any references to ‘above’ or ‘below’, ‘upper’ or ‘lower’ herein refer to an orientation of the photovoltaic cell in which the IR radiation is incident at the top of the film.

As used herein, the term “focal plane array” or “FPA” refers to an image sensor composed of an array of sensor elements (e.g., light sensing pixels) arranged at the focal plane of an imaging unit, such as an imaging lens assembly (e.g., a single or compound lens).

As used herein, a “FPA sensor module” is a modular FPA. In addition to the FPA sensor itself, a FPA sensor module can include additional components such as packaging for integrated circuits and/or connectors or interfaces for connecting the FPA sensor modules to other components.

As used herein, a “composite focal plane array” or “CFPA” is an image sensor composed of multiple FPAs arranged at a common focal plane, e.g., of a single imaging unit or multiple imaging units.

As used herein, the term “sensor group” refers to a grouping of FPA sensor modules arranged in a field of view of an optical imaging unit, such as an imaging lens assembly.

Here and throughout the specification, reference to a measurable value such as an amount, a temporal duration, and the like, the recitation of the value encompasses the precise value, approximately the value, and within ±10% of the value. For example, here 100 nanometer (nm) includes precisely 100 nm, approximately 100 nm, and within ±10% of 100 nm.

For simplicity and clarity of illustration, reference numerals may be repeated among the figures to indicate corresponding or analogous elements. Numerous details are set forth to provide an understanding of the examples described herein. The examples may be practiced without these details. In other instances, well-known methods, procedures, and components have not been described in detail to avoid obscuring the examples described.

The present disclosure provides systems and techniques for updating a sensor calibration model for a composite focal plane array (CFPA) imaging system. Such features facilitate optimizing the overlap and alignment between images from individual FPA sensor modules to generate geometrically seamless composite images.

The CFPA imaging system utilizes image overlap designed into the placement of the imaging sensor modules within the focal plane of mounted lenses. Given the size of WAMI imagery and use of multiple camera front-end electronics, the approach can also applied in a distributed acquisition system where subsets of acquired focal planes reside on separate processing nodes.

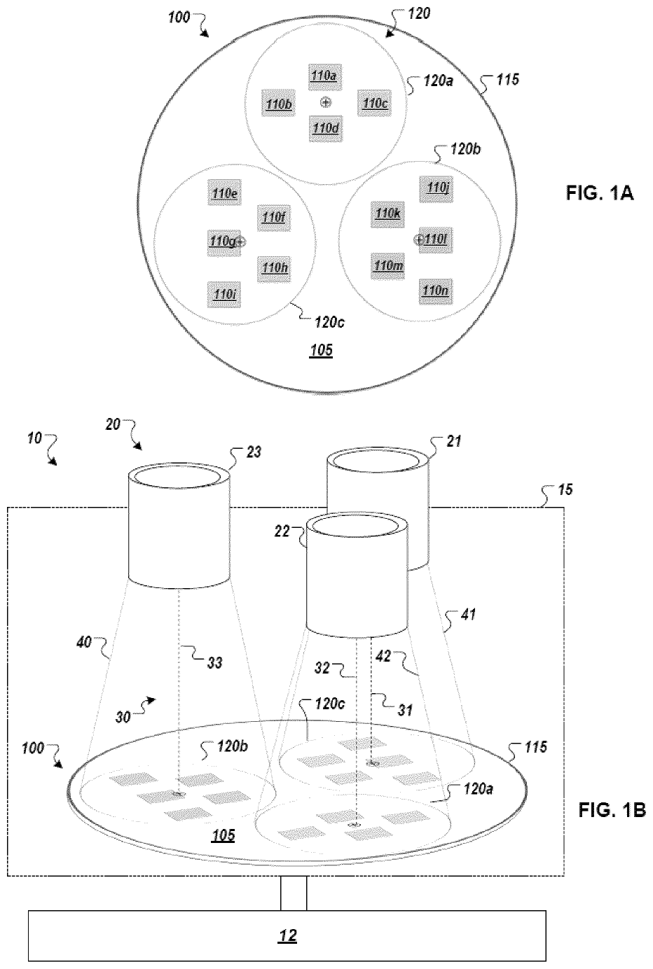

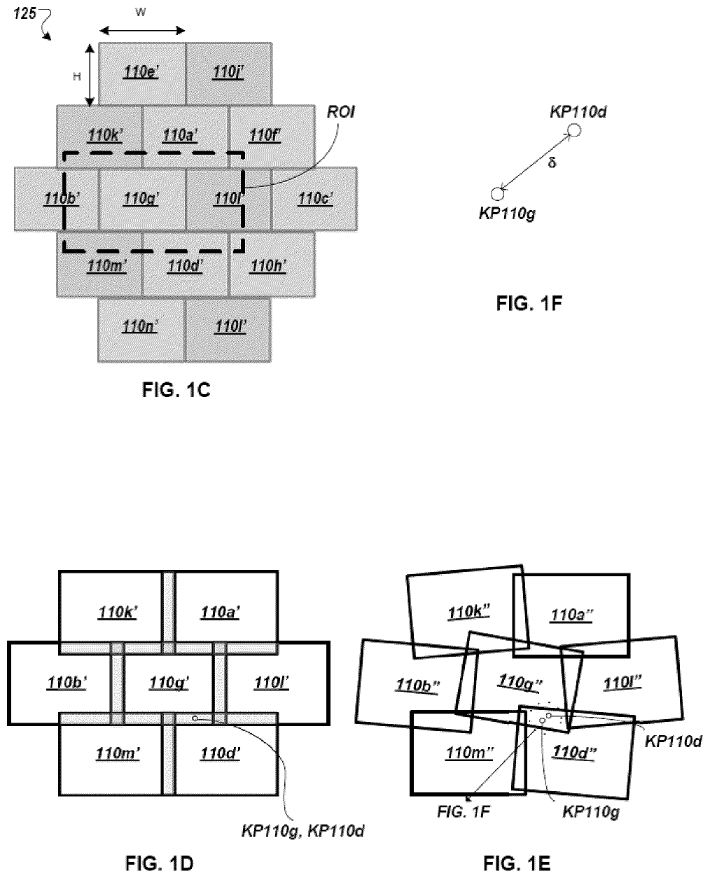

An exemplary imaging system is shown in FIGS. 1A and 1B. This system includes, in part, a CFPA camera 10 with three lens assemblies 21-23 and a CFPA board 100 is shown in FIGS. 1A and 1B. The CFPA camera 10 is interfaced with an image processing module 12, arranged in close proximity to the CFPA camera 10. As will be described in more detail below, image processing module 12 processes image data from the CFPA camera 10 to generate composite images, i.e., images composed of image data from more than one of the FPA sensor modules in CFPA camera 10. The image processing includes applying a sensor geometric calibration model to the image data in order to reduce artifacts in the composite image due to time-varying physical and/or optical variations of components in CFPA camera 10.

The lens assemblies 21-23 and CFPA board 100 are arranged in a housing 15, which mechanically maintains the arrangement of the elements of the camera and protects the camera from environmental sources of damage or interference. Board 100 includes a substrate 115 (e.g., but not limited to, PCB or ceramic substrate) and fourteen discrete FPA sensor modules 110a-110n, collectively “FPA sensor modules 110,” are mounted on a surface 105 of the PCB. Each of the FPA sensor modules 110 includes a pixelated array of light detector elements which receive incident light through a corresponding one of the lens assemblies 21-23 (collectively, “lens assemblies 20”) during operation of the system. An optical axis 21-23 of each lens assembly 21-23 is also shown. The optical axes 21-23 are parallel to each other within the angle of the overlapping edges between FPAs (e.g., about O(100) μrad or less).

Because an image field of each lens assembly 21-23 extends over an area that encompasses multiple sensor modules, each discrete sensor module receives a portion of the light imaged onto the CFPA board 100. During operation, each of the lens assemblies 20 receive incident light from a distant object (or scene containing multiple objects) and image the light onto the corresponding focal plane. The FPA sensor modules 110 converts the received light into signals containing information about the light intensity at each pixel.

The FPA sensor modules 110 are arranged in three sensor groups 120a, 120b, and 120c, collectively, “sensor groups 120.” Each sensor group 120a-c corresponds to one of the lens assemblies 21-23 such that the sensors in each group receive light imaged by their corresponding lens assembly.

The FPA sensor modules 110 can be permanently mounted to the substrate 115 or can be replaceable. In examples which include replaceable sensor modules, substrate 115 includes sockets and/or wells which enable local connections at the perimeter of the FPA sensor modules 110. Alternatively, or additionally, FPA sensor modules 110 can be interfaced to electrical connections directly at the perimeter, such as, but not limited to, hard-wiring of the FPA sensor modules 110 to the substrate 115.

In some examples, substrate 100 includes one or more actuators for controlling relative alignment of each sensor group 120a-c relative to the optical axes 31-33 and/or the focal planes of each lens assembly 21-23. The actuators can include, but are not limited to, for example, shims or piezoelectric spacers. The actuators act as leveling devices that compensate for the surface variations of the substrate 115 in the axial direction, e.g., but not limited to, the optical axes direction, or the direction normal to the surface 105.

In general, the FPA sensor modules 110 are sensitive to electromagnetic radiation in an operative range of wavelengths. Depending on the implementation, the operative wavelength range can include visible light, e.g., visible light of a specific color, infrared (IR) light, and/or ultraviolet (UV) light. In some non-limiting examples, the FPA sensor modules 110 are sensitive to a wavelength range that includes from about 0.35 μm to about 1.05 μm (e.g., about 0.35 μm to about 0.74 μm, about 0.40 μm to about 0.74 μm). In some examples the FPA sensor modules 110 are sensitive to IR light having wavelengths from about 0.8 μm to about 12 μm (e.g., about 0.9 μm to about 1.8 μm, about 0.9 μm to about 2.5 μm).

Some nonlimiting examples of the FPA sensor modules 110 include arrays of CMOS sensors, photodiodes, or photoconductive detectors. Each of the FPA sensor modules 110 have a resolution corresponding to the dimensions of the array of light detectors, commonly referred to as ‘pixels.’ The resolution of the FPA sensor modules 110 is such that when the signals received from the FPA sensor modules 110 are converted to images and subsequently merged into a mosaic image, the mosaic image resolution achieves a desired threshold. Some examples of resolution of the FPA sensor modules 110 include, but are not limited to, 1024×1024, 3072×2048 or even larger commercially-available arrays (e.g., 16,384×12,288, which represents the largest array presently known).

In general, each FPA sensor module produces an image of a small portion (e.g., about 20% or less, about 10% or less, such as about 5% to about 10%) of the overall field of view of the camera. The image processing module 12 then constructs a larger, composite image of, e.g., the entire field of view or a region of interest (ROI) encompassing images from more than one FPA sensor module, by appropriately arranging the image from each FPA sensor module relative to the other images. Such a composite image is a “mosaic” image. A nonlimiting example of a mosaic image 125 in a brick wall configuration constructed from images from each FPA sensor module 110 is shown in FIG. 1C. The FPA sensor modules 110 of each of the sensor groups 120 are arranged such that the portion of the focal plane imaged by each of FPA sensor modules 110 are interleaved to form the mosaic image representing the object plane. In one example, the FPA sensor of each FPA sensor module is mounted on the planar topside surface of a substrate, with an inactive electrical component (for example, a cable or flex PCB) extending from the sensor and through a corresponding hole in the substrate to a corresponding readout device disposed on the opposite side (on the backside surface) of the substrate. The inactive electrical component and the readout electronics may be considered part of the FPA sensor module along with the FPA sensor itself. The structure of such an FPA sensor module is set forth in the United States patent application entitled “Systems And Devices For Composite Focal Plane Array Sensors,” patent application Ser Ser. No. 18/384,813, by Antoniades et al, filed Oct. 28, 2023 (the entire subject matter of which is incorporated herein by reference).

The signals received by the readout electronics from the FPA sensor modules 110 are converted into image data. Each of the FPA sensor modules 110 produces an associated image including a portion of the imaged light from the lens elements 20. For example, FPA sensor module 110a produces signals which is received by readout electronics to produce a corresponding image 110a′, FPA sensor module 110b produces a signal which is received by the readout electronics to produce image 110b′, etc. In this manner, each of the FPA sensor modules 110 produces signals which are converted into a corresponding one of images 110a′-110n′.

In one example, each FPA sensor is an instance of the commercially available OVAOB 100 megapixel CMOS image sensor, available from Omnivision Technologies Inc. The CMOS image sensor comprises an individual CMOS semiconductor integrated circuit die and a package that contains the semiconductor integrated circuit die.

The imaging processing system interleaves the images 110a′-110n′ according to the arrangement of the FPA sensor modules 110 on the PCB 115 of FIGS. 1A and 1B. In general, the arrangement of each of the FPA sensor modules 110 within the respective sensor groups 120 is maintained within the composite, mosaic image 125. For example, sensor group 120a includes FPA sensor modules 110a, 110b, 110c, and 110d arranged in a diamond shape. Images 110a′-110d′ are arranged within the mosaic image 125 according to the same diamond shape. Similarly, the images 110e′-110n′ of sensor group 120b and sensor group 120c are arranged to correspond with the arrangement of the associated FPA sensor modules 110e-110n within their respective sensor groups 120b and 120c. The layout arranges the FPA sensor modules 110 such that the corresponding images 110a′-110n′ are arranged in a brick wall configuration when interleaved to form the mosaic image 125.

In the present example, each FPA sensor module is rectangular in shape and produces a corresponding rectangular image (of height H and width W). However, CFPAs may be implemented with other shapes of FPAs, such as square, hexagonal, or other polygon, etc.

Moreover, while the example CFPA camera described above includes a specific arrangement of FPA sensor modules, lens assemblies, and other components, in general, other arrangements are possible. For instance, while the CFPA camera 10 includes three lens assemblies, other arrangements can be used (e.g., but not limited to, one, two, or more than three lens assemblies). Additionally, each sensor group is depicted as including either four or five FPA sensors in FIGS. 1A and 1B. However, other numbers of sensors can be grouped (e.g., but not limited to, fewer than four, such as two or three, or more than five).

Furthermore, while images 110a′-110n′ in the composite image are depicted as having edges of adjacent images completely aligned, adjacent images in a composite projection overlap with one another as delineated in FIG. 1D for a subset of the images corresponding to the ROI shown in FIG. 1C. In FIG. 1D, the overlapping regions are shaded.

For a calibrated system, the sensor calibration model projects the images in the composite image relative to one another so that image features in overlapping image portions perfectly overlap in the composite image when projected by the image processing module. However, due to a variety of physical and optical imperfections in the CFPA imager, images can become misaligned with respect to each other as delineated in FIG. 1E. Absent an algorithm for proper calibration to account for the imperfections, image misalignment can result in a displacement of image features in overlapping image portions. This effect is illustrated by an image feature common to image 110g′ and 110d′, labelled KP110g and KP110d. In FIG. 1D, which depicts a composite generated from an accurately calibrated system, these points overlap. However, for a system that is improperly calibrated, these points are displaced relative to each other. The displacement is shown as vector □ for image points KP110d and KP110g in FIG. 1F.

A number of parameters characterizing the physical arrangement of components and the optics of each sensor group in a CFPA camera affect the misalignment of image points in a composite image. These parameters can be used to optimize a sensor calibration model useful for reducing artifacts in a composite image due to time-dependent variations in the CFPA camera. The sensor calibration model parameterization utilizes shared internal parameters of a CFPA camera, which refer to parameters that are shared by more than one of the FPA sensor modules in a sensor group. For example, the multiple FPA sensor modules of a sensor group of a CFPA camera share the same underlying optical parameters of their shared lens assembly, including a focal length, a distortion, and an optical center. Using shared internal parameters reduces the total number of parameters in the calibration model compared with a calibration model in which each FPA sensor module which increases the speed of determining the optimized solution by reducing the overall parameter space the optimization algorithm must minimize over.

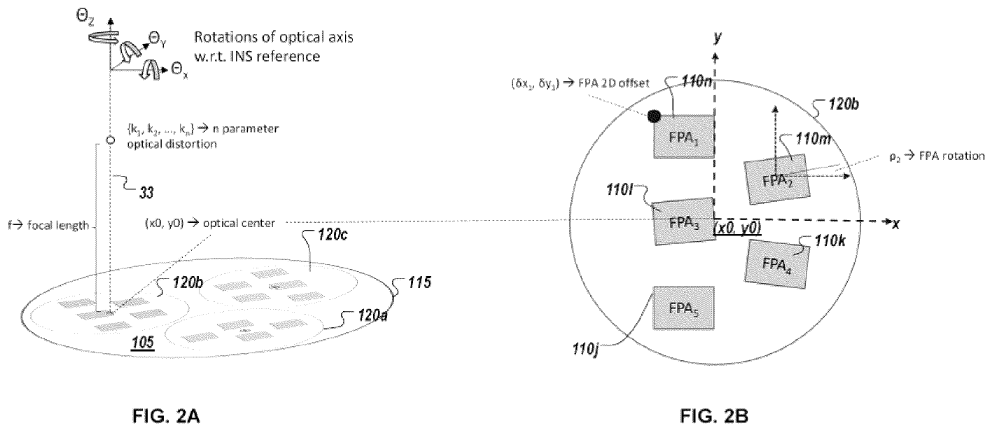

Examples of physical and optical parameters that can be used for parameterization of the sensor calibration model are delineated in FIGS. 2A and 2B, which show portions of the CFPA camera 10. An optical center of each sensor group is establish as the location at which the optical axis of the related lens assembly intersects the image plane. This location can be used as an origin for a coordinate system for each sensor group to establish a position and angular orientation of each FPA sensor module in the sensor group. For instance, each FPA sensor module has a 2D offset from the origin (x0, y0), corresponding to the x-y coordinates of, e.g., a corner pixel of the FPA sensor module. Further, each FPA sensor module's orientation is parameterized by a rotation angle, □, corresponding to the angular offset of the x-aligned edge of the FPA sensor module with respect to the x-axis.

Additional shared internal parameters include the focal length of the lens assembly and parameters characterizing image distortion and/or radial and tangential imaging aberrations of the lens assembly (e.g., but not limited to, expressed as Zernike polynomials or other polynomial bases for characterizing optical aberrations).

The sensor calibration model can also be parametrized by shared external parameters including, for example, rotations of the optical axes of each lens assembly with respect to a global reference frame, such as a reference frame established from an inertial navigation system (INS).

An additional external parameter include 3D translation of the camera system from a reference (e.g., but not limited to, INS location), which is a shared parameter. For CFPA systems that use reflective optics (e.g., but not limited to, one or more mirrors) to control field angles, the angles of the reflective assembly can be shared external parameters. Additional, unshared internal parameters can include individual FPA sensor module skew (as might be encountered in rolling shutter system), for example.

The sensor calibration model establishes the 2D lateral position and rotation for each of the FPA sensor modules with respect to their local frame of reference (e.g., the Cartesian coordinate system corresponding to the optical axis (z-axis) and the x-y plane of the sensor group).

While the example described above includes a specific arrangement of FPA sensor modules, lens assemblies, and other components, in general, other arrangements are possible. For instance, while the CFPA camera 10 includes three lens assemblies, other arrangements can be used (e.g., but not limited to, one, two, or more than three lens assemblies). Moreover, each sensor group is depicted as including either four or five FPA sensors. However, other numbers of sensors can be grouped (e.g., but not limited to, fewer than four, such as two or three, or more than five).

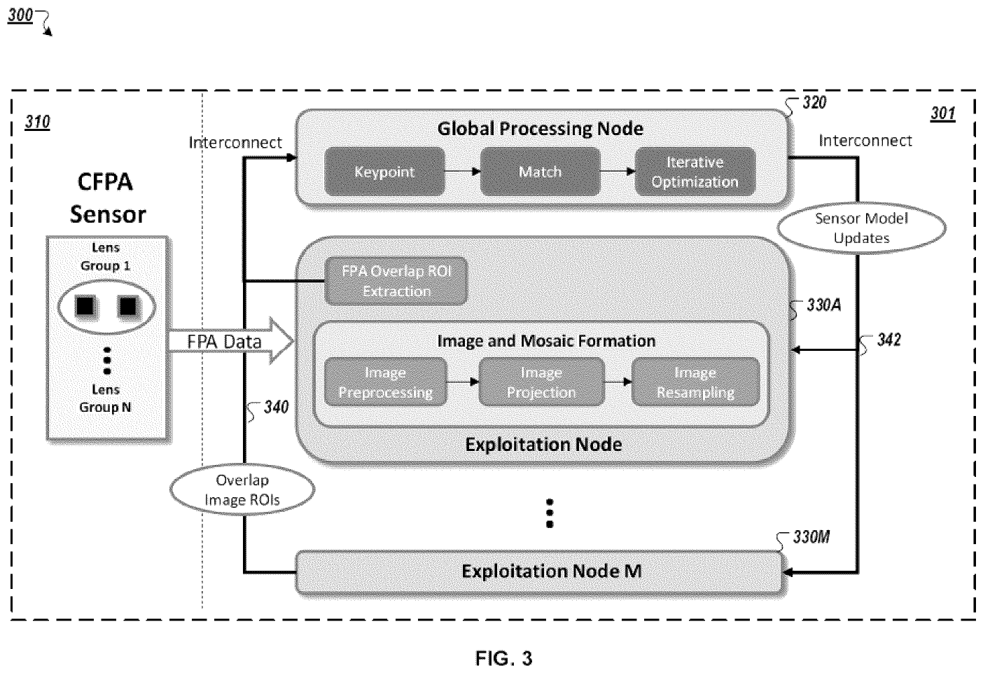

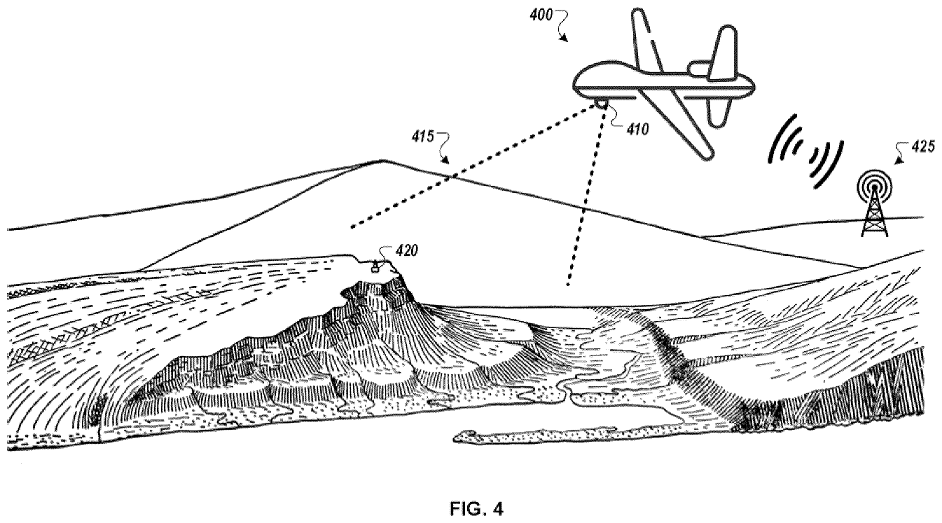

An exemplary image processing module 301 for a CPFA imaging system 300 is delineated in FIG. 3. Imaging system 300 includes a CFPA camera 310 composed of N total lens groups that is in electrical communication with processing system 301, e.g., via cabling and/or wireless data transfer. An example CFPA camera is shown camera 10, described above. Image processing module 301 is housed with or near CFPA sensor 310 and provide processing local to the platform in which the CFPA imaging system 300 is installed.

Image processing module 301 is programmed to perform an in-situ, real-time calibration of camera 310 to generate updates to a sensor calibration model used to reduce misalignment of images from individual FPA sensor modules in a composite image.

Processing system 301 includes a series of nodes including a global processing node 320 and M exploitation nodes 330A-330M. In some examples, each FPA sensor module has a corresponding exploitation node. The nodes are in communication with each other via interconnects 340 and 342, which facilitate communication of data between the exploitation nodes 330 and the global processing node 320. As delineated, interconnect 340 provides data from exploitation nodes 330 to global processing nodes 320 and interconnect 342 provides data from global processing node 320 to exploitation nodes 330. The global processing node 320 and exploitation nodes 330A-330M can be implemented using one or several processing units (e.g., central processing units (CPU) and/or graphical processing units (GPUs)). In some cases, each node is implemented using a separate processing unit. Alternatively, multiple nodes can be implemented using a single processing unit. In certain cases, a single node can be implemented using more than one processing unit (e.g., across two or three processing units).

The in-situ calibration method distributes the overlapping regions of the individual images from the FPA sensor modules to a global processing node of the overall data processing system onboard the WAMI platform. The overlapping regions undergo image processing on the central processing node to develop correspondences (e.g., matching ‘key points’) between pair-wise sets of overlapping regions. The set of correspondences are provided as input to an optimization algorithm which solves for sensor parameter values which minimize a cost function based on the combined set of correspondences.

In general, the cost function is a mathematical function that provides a quantifiable measure of the composite image quality. An example cost function is the total reprojection error summed over all key point correspondences between overlapping ROI images. The error for a single key point can be based on backprojecting a ray from the pixel established by the key point (or correspondence point), intersecting the ground, and reprojecting the 3D world coordinate into the corresponding overlap image. The backprojection first accounts for the individual FPA position, then applies the shared internal parameters for the lens group, and subsequently applies the shared external parameters to orient the ray and intersect the ground. Projection from that ground point implements this process in reverse. When applied to all points, the total sum represents the quality of alignment of the entire system.

Global processing node 320 establishes correspondences of key points by first establishing key points in the overlapping imagery and determining a match via an image similarity metric (e.g., normalized cross-correlation). Key points can be determined, for example, by analyzing image intensity gradient information to establish pixels with good ‘localization’ properties: namely, a vertical and/or horizontal gradient (i.e., a ‘point’) that exceeds a preset threshold corresponding to a unambiguously identifiable image feature. Cross correlation as a match-metric seeks to maximize the correlation between two image regions—it will be maximized when the regions contain similar content, and the match will be distinguished and readily established if that content is effectively a readily identified point. Image intensity normalization can be used to ensure a level of invariance to intensity differences that may result from acquisition through multiple different lens assemblies as may be encountered with CFPA sensors such as CFPA sensor 10.

Key point matches are gathered together from multiple successive frames acquired over a short time scale (e.g., on the order of seconds or fractions of a second)—generally, the resulting optimization is valid if the time scale of key point generation is shorter than the parameter variation. For airborne systems, the variations can take tens of minutes, so points gathered over tens of seconds are permissible. The use of multiple frames allows the FPA sensor module overlaps to image different regions in the field of view with improved key point content (e.g., some frames may be of a region with little variation in image color and/or contrast, such as a forest, that can provide no key points based on the intensity gradient threshold, but a few seconds later, it may include a different area with numerous potential key points, e.g., but not limited to, an urban area). Useful key points are useful in each overlap to solve for the parameters associated with those FPAs, so using more frames in time helps facilitate this need.

Each exploitation node 330A-M is programmed to extract overlapping image data for the ROI of the composite image. The exploitation nodes send the overlapping image data to the global processing node 320 for key point identification via interconnect 340.

Global processing node 320 is programmed to identify key points in the overlap imagery, compute key point correspondences to match key points, formulate input for the optimization algorithm, and iteratively optimize a calibration model for sensor 310 by executing the optimization algorithm.

The global processing node 320 updates the sensor calibration model using an iterative global optimization over a cost function. The cost function minimizes a total weighted reprojection error summed over all correspondences determined across all overlapping regions (e.g., but not limited to, as a least-squares error). The weighting is applied to increase the influence of a subset of the correspondences (e.g., but not limited to, for match-confidence or to ensure that certain FPA regions of the array are aligned at the expense of others). The iterations continue until the total reprojection error is reduced below a threshold or the number of iterations exceeds a threshold. Optimization can be based on nonlinear least squares algorithm: it is ‘nonlinear’ because the sensor model relating pixel-to-pixel is nonlinear (including projective division and distortion polynomials). Alternative formulations can also include robust nonlinear optimization (‘robust’ to account for outliers in potential correspondences). This algorithm adapts a ‘bundle adjustment’ approach to a CFPA in live operation with shared internal parameters. Use of shared parameters reduces the overall number of parameters and thus, the complexity of the underlying calculation.

When the optimization algorithm completes (i.e., converges to a value that meets a threshold convergence condition), the resulting sensor calibration model parameter refinements are distributed via interconnect 342 to the exploitation nodes 330A-M. The exploitation nodes 330A-M use the updated model in live mosaic creation with an updated optimal parameter set to provides geometrically seamless images in videos and/or still images composed of mosaics (i.e., any image product that uses images from multiple FPA sensor modules together). By using shared internal parameters, the computational expense of updated the sensor calibration model is reduced on the global processing node 320. Due to the reduced computational expense compared to conventional sensor calibration, it may be feasible to use the disclosed approach in live operation for large-scale CFPAs.

The resulting solution (i.e., the optimized values for each of the sensor calibration model parameters) is distributed to image acquisition nodes of the data processing system, so incoming images from the focal planes can be interleaved to form the mosaic image in a straightforward way, e.g., output pixels in the mosaic image are projected from the output projection coordinate system back to pixels of the FPA sensor images using the optimized parameters of the calibration model.

The optimization algorithm can be run for each frame acquisition, periodically over multiple frame acquisitions, or intermittently, e.g., on an as need basis. In some examples, the optimization algorithm for the sensor calibration model is triggered manually by an operator. In certain cases, the optimization is triggered automatically, e.g., if environmental parameters change beyond a specified threshold.

In general, the CFPA imaging systems described herein have useful applications in many different areas. On the public safety front, they provide deterrent for crime, and tools for crime investigations and evidence gathering. The CFPA camera systems provide live coverage of huge areas to aid in rescue efforts in disaster situations, providing a rapid means of assessing damage to speed up the rebuilding process, monitoring very large areas including wildfires (e.g., >30,000 acres at once) to guide the firefighting efforts, find safe zones for those who are surrounded and facilitate prediction of fire evolution days in advance. The CFPA camera systems provide wide area persistent data needed for smart and safe cities, such as during riots and large crowd events. Additionally, the CFPA camera systems are useful for coastal monitoring, conservation, news coverage, and port and airport security.

The CFPA imaging system 410 having implementing the in-situ calibration method disclosed herein can be used in an aerial vehicle, a satellite, or elevated observation platform. In certain examples, the devices and systems are used for wide area persistent motion imaging, described above. An example aerial observation system useful for wide area persistent motion imaging, specifically an unmanned aerial vehicle 400 (or “drone 400”), is shown in FIG. 4. Drone 400 includes CFPA imaging system 410 for capturing imagery within a field of view (FOV) 415, and specifically implements the in-situ calibration method disclosed herein. A controller directs the CFPA camera of the system to image one or more targets, e.g., target 420, in response to commands received from a remote or local controller. Drone 400 also includes a communications module for wirelessly transmitting data from the imaging system 400 to a remote communications platform 425 and receiving control commands from a remote controller (e.g., the same or different from communications platform 425). CFPA imaging system 410 can include an actuation module which mechanically reorients the CFPA camera to change the field of view and/or retain the same field of view as the drone moves. A controller onboard drone 400 can perform processing of image data acquired by imaging system 410 to generate, or facilitate remote generation of, images and/or video.

In addition to drones, exemplary observation systems can include manned aerial vehicles include airplanes and helicopters. Dirigibles can also be used. In some examples, observation systems can be mounted to a stationary observation platform, such as a tower.

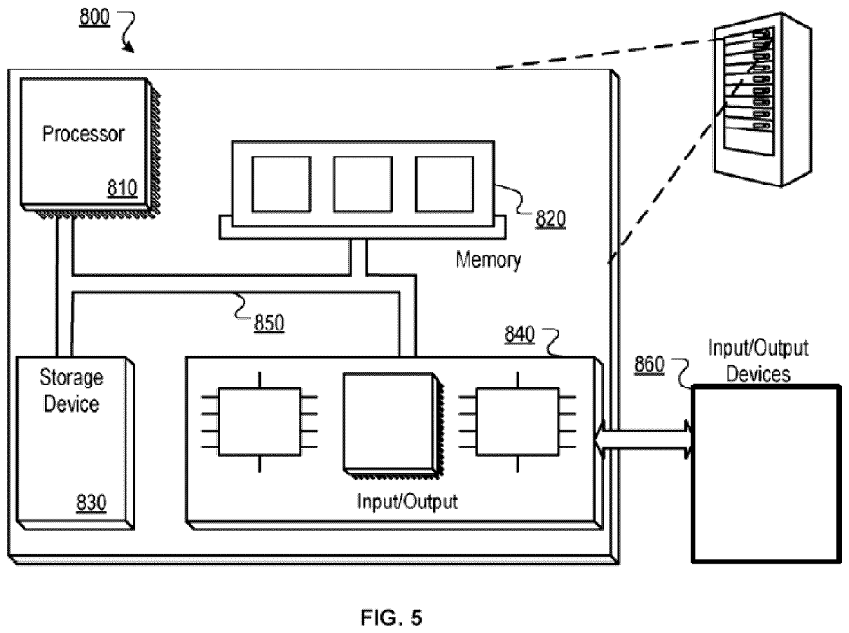

A block diagram of an exemplary computer system 800 that can be used to perform operations described previously is delineated in FIG. 5. Computer system 800 can be used or adapted for use as the image processing module 301. The system 800 includes a processor 810, a memory 820, a storage device 830, and an input/output device 840. Each of the components 810, 820, 830, and 840 are interconnected, for example, using a system bus 850. The processor 810 processes instructions for execution within the system 800. In some implementations, the processor 810 is a single-threaded processor. Alternatively, the processor 810 can be a multi-threaded processor. The processor 810 processes instructions stored in the memory 820 or on the storage device 830.

The memory 820 stores information within the system 800. In one implementation, the memory 820 is a computer-readable medium. In one implementation, the memory 820 is a volatile memory unit. In another implementation, the memory 820 is a non-volatile memory unit.

The storage device 830 provides mass storage for the system 800. In one implementation, the storage device 830 is a computer-readable medium. In various different implementations, the storage device 830 includes, for example, a hard disk device, an optical disk device, a storage device that is shared over a network by multiple computing devices (e.g., but not limited to, a cloud storage device), or some other large capacity storage device.

The input/output device 840 provides input/output operations for the system 800. In some examples, the input/output device 840 includes one or more network interface devices, e.g., but not limited, an Ethernet card, a serial communication device, e.g., but not limited to, an RS-232 port, and/or a wireless interface device, e.g., but not limited to, and 802.11 card. In certain implementations, the input/output device 840 includes driver devices configured to receive input data and send output data to other input/output devices, e.g., but not limited to, a keyboard, keypad and display devices 860. Other implementations, however, can also be used, such as, but not limited to, mobile computing devices, mobile communication devices, and set-top box client devices.

Although an example processing system has been described in FIG. 5, implementations of the subject matter and the functional operations described in this specification can be implemented in other types of digital electronic circuitry, or in computer software, firmware, or hardware, including the structures disclosed in this specification and their structural equivalents, or in combinations of one or more of them.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., but not limited to, a machine-generated electrical, optical, or electromagnetic signal that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., but not limited to, an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A “computer program,” which may also be referred to or described as a “program,” “software,” “software application,” “app,” “module,” “software module,” “script,” or “code”, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., but not limited to, one or more scripts stored in a markup language document, in a single file dedicated to the program in question, or in multiple coordinated files, e.g., but not limited to, files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine is implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., but not limited to, an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit receives instructions and data from a read-only memory or a random access memory or both. The elements of a computer are a central processing unit for performing or executing instructions and one or more memory devices for storing instructions and data. The central processing unit and the memory can be supplemented by, or incorporated in, special purpose logic circuitry. In some cases, a computer also includes, or can be operatively coupled to receive data from or transfer data to, or both, one or more mass storage devices for storing data, e.g., but not limited to, magnetic, magneto-optical disks, or optical disks. However, a computer need not have such devices. Moreover, a computer can be embedded in another device, e.g., but not limited to, a mobile telephone, a personal digital assistant (PDA), a mobile audio or video player, a game console, a Global Positioning System (GPS) receiver, or a portable storage device, e.g., but not limited to, a universal serial bus (USB) flash drive, to name just a few.

Computer-readable media suitable for storing computer program instructions and data include all forms of non-volatile memory, media and memory devices, including by way of example semiconductor memory devices, e.g., but not limited to, EPROM, EEPROM, and flash memory devices; magnetic disks, e.g., internal hard disks or removable disks; magneto-optical disks; and CD-ROM and DVD-ROM disks.

To provide for interaction with a user, examples can be implemented on a computer having a display device, e.g., but not limited to, a LCD (liquid crystal display) monitor or light emitting diode (LED) monitor, for displaying information to the user and a keyboard and a pointing device, e.g., but not limited to, a mouse or a trackball, by which the user provides input to the computer. Other kinds of devices can be used to provide for interaction with a user as well; for example, feedback provided to the user can be any form of sensory feedback, e.g., but not limited to, visual feedback, auditory feedback, or tactile feedback; and input from the user can be received in any form, including acoustic, speech, or tactile input.

It is to be understood that the above description is intended to be illustrative, and not restrictive. Many other implementations will be apparent to those of skill in the art upon reading and understanding the above description. Although the present disclosure has been described with reference to specific example implementations, it will be recognized that the disclosure is not limited to the implementations described but can be practiced with modification and alteration within the scope of the appended claims. Accordingly, the specification and drawings are to be regarded in an illustrative sense rather than a restrictive sense. Although various features of the approach of the present disclosure have been presented separately (e.g., in separate figures), the skilled person will understand that, unless they are presented as mutually exclusive, they may each be combined with any other feature or combination of features of the present disclosure. While this specification contains many details, these should not be construed as limitations on the scope of what may be claimed, but rather as descriptions of features specific to particular examples. Certain features that are described in this specification in the context of separate implementations can also be combined. Conversely, various features that are described in the context of a single implementation can also be implemented in multiple examples separately or in any suitable subcombination. Those skilled in the art will recognize, or be able to ascertain, using no more than routine experimentation, numerous equivalents to the specific examples described specifically herein. Such equivalents are intended to be encompassed in the scope of the following claims.

What is claimed is:

1. An unmanned aerial vehicle comprising a composite focal plane array (CFPA) imaging system, the CFPA imaging system comprising:
a plurality of lens assemblies each arranged to image light from a common field of view to a corresponding image field at a focal plane of each lens assembly;
a plurality of focal plane array (FPA) sensors arranged on a planar substrate in a plurality of sensor groups, each sensor group arranged at the focal plane of one of the lens assemblies corresponding to the sensor group, wherein each FPA sensor in each of the sensor groups is positioned such that each FPA sensor acquires an image of a different portion of the common field of view of the lens assemblies; and
an image processing module arranged to receive image data from the plurality of FPA sensors and compile a composite image comprising image data from at least two of the FPA sensors, wherein the at least two of the FPA sensors acquire images of adjacent portions of the common field of view and the image data from the at least two FPA sensors comprises overlapping image data, the image processing module comprising:
a first processing node that receives the overlapping image data and that generates an update for a sensor calibration model based on one or more key points common to the overlapping image data; and
a plurality of additional processing nodes, wherein each of the additional processing nodes receives image data from a corresponding one of the FPA sensors, wherein the plurality of additional processing nodes receives the image data from the plurality of FPA sensors, applies the sensor calibration model to the image data to generate corrected image data, and compiles the composite image using the corrected image data, wherein there is a one-to-one relationship between the processing nodes of the plurality of additional processing nodes and the FPA sensors of the plurality of FPA sensors.

2. An imaging system for a composite focal plane array (CFPA) imaging system, comprising:
a plurality of lens assemblies each arranged to image light from a common field of view to a corresponding image field at a focal plane of each lens assembly;
a plurality of focal plane array (FPA) sensor modules each arranged in a plurality of sensor groups, each sensor group arranged at the focal plane of one of the lens assemblies corresponding to the sensor group, wherein each FPA sensor module in each of the sensor groups is positioned such that each FPA sensor module acquires an image a different portion of the common field of view of the lens assemblies; and
an image processing module arranged to receive image data from the plurality of FPA sensor modules and compile a composite image comprising image data from at least two of the FPA sensor modules, wherein the at least two of the FPA sensor modules acquire images of adjacent portions of the common field of view and the image data from the at least two FPA sensor modules comprises overlapping image data, the image processing module comprising:
a first processing node programmed to receive the overlapping image data and generate an update for a sensor calibration model based on one or more key points common to the overlapping image data from the at least two FPA sensor modules; and
a plurality of additional processing nodes programmed to receive the image data, apply the sensor calibration model to the image data to generate corrected image data, and compile the composite image using the corrected image data from the at least two FPA sensor modules.

3. The imaging system of claim 2, wherein the sensor calibration model comprises one or more internal parameters, the internal parameters being parameters characteristic of each lens assembly.

4. The imaging system of claim 3, wherein the internal parameters are shared by more than one of the FPA sensor modules, and wherein the shared internal parameters are selected from the group consisting of: a focal length, an optical center, and a lens distortion (e.g., expressed as a polynomial function or using a look up table).

5. The imaging system of claim 2, wherein the sensor calibration model comprises one or more external parameters, the external parameters being parameters characteristic of each lens assembly that are different for each FPA sensor module in a sensor group.

6. The imaging system of claim 5, wherein the external parameters are shared by more than one of the FPA sensor modules, and wherein the shared external parameters comprise three angles of optical axis rotation.

7. The imaging system of claim 2, wherein the sensor calibration model comprises parameters characterizing a location and/or an orientation of an FPA sensor module.

8. The imaging system of claim 2, wherein the first processing node is programmed to identify the key points from the overlapping image data, and wherein the key points are identified based on a two-dimensional intensity gradient in the overlapping image data.

9. The imaging system of claim 2, wherein the first processing node is programmed to identify the key points from the overlapping image data, and wherein the key points are identified as a feature in the overlapping image data from the at least two of the plurality of FPA sensor modules for which an intensity gradient exceeds a threshold in two orthogonal directions.

10. The imaging system of claim 2, wherein the image processing module comprises an interconnect for distributing the image data among the first processing node and the plurality of additional processing nodes, and wherein the plurality of FPA sensor modules are arranged relative to the lens assemblies such that the FPA sensor modules collectively image a continuous area across the field of view.

11. A method of forming a composite image using a composite focal plane array (CFPA), the method comprising:
imaging light from a common field of view to a plurality of sensor groups using a plurality of lens assemblies, each sensor group comprising a plurality of focal plane array (FPA) sensor modules, the plurality of FPA sensor modules all being arranged on a surface of a substrate;
acquiring an image using each of the FPA sensor modules, each image corresponding to a different portion of the common field of view;
receiving image data from the plurality of FPA sensor modules including image data from at least two of the FPA sensor modules, wherein the at least two of the FPA sensor modules acquire images of adjacent portions of the common field of view and the image data from the at least two FPA sensor modules comprises overlapping image data;
generating an update for a sensor calibration model based on one or more key points common to the overlapping image data from the at least two FPA sensor modules;
applying the sensor calibration model to the image data to generate corrected image data; and
compiling a composite image using the corrected image data from the at least two FPA sensor modules.

12. The method of claim 11, wherein the sensor calibration model comprises one or more internal parameters, the internal parameters being parameters characteristic of each lens assembly that apply to each FPA sensor module in a sensor group, wherein the internal parameters are selected from the group consisting of: a focal length, an optical center, and a lens distortion.

13. The method of claim 12, wherein the sensor calibration model further comprises one or more external parameters, the external parameters being parameters characteristic of each lens assembly that are different for each FPA sensor module in a sensor group, wherein the external parameters comprise three angles of optical axis rotation.

14. The method of claim 11, wherein the update for the sensor calibration model is determined by a first processing node by optimization of a cost function related to a correspondence between key points in the overlapping image data, and wherein the optimization is a nonlinear least squares optimization.
